(19) United States
(12) Patent Application Publication
(10) Pub. No.: US 2006/0243549 A1
(43) Pub. Date: Nov. 2, 2006

(54) Magnetic bearings for damping and/or isolation systems

(75) Inventor: Ken E. Young, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/118,941

(22) Filed: Apr. 28, 2005

(51) Int. Cl. F16F 15/03

(52) U.S. Cl. 188/267; 188/164

(57) ABSTRACT

A system is provided for damping and/or isolating vibration of a mass. The system comprises a housing, a shaft, a housing magnet, and a shaft magnet. The housing has an inner surface defining a passage. The shaft is disposed within said passage of said housing and configured to move axially therein. The shaft has an outer surface. The housing magnet is coupled to the housing inner surface. The shaft magnet is coupled to the shaft outer surface and is in alignment with the housing magnet and configured to repel the housing magnet.

### FIELD OF THE INVENTION

The present invention generally relates to reducing vibration experienced by a mass, and more particularly relates to a damping and/or isolation system for reducing low disturbance forces.

### BACKGROUND OF THE INVENTION

A precision pointing system carrying a sensor, such as a telescope, may be susceptible to disturbances that produce structural vibrations and, consequently, pointing errors. Such vibrations may be attributed to mechanical components or assemblies, such as reaction wheel assemblies, that are used as actuators in the precision pointing system. For the most part, because these systems tend not to have significant, inherent damping, these structural vibrations may degrade system performance and even cause structural fatigue over time. Therefore, an efficient means of providing vibration damping and/or isolation to the system may be needed.

In some circumstances, a passive-mass damping system is used for damping the structure and isolating the payload carried by the precision pointing system. Passive-mass damping systems may have any one of numerous configurations. In one example, the system includes a container having a mass and a spring mounted therein. Fluid is also disposed within the container to provide damping by shearing the fluid. The mass includes a plurality of troughs formed around its outer periphery, and a ball is disposed within each of the troughs. The balls bear against the inner surface of the container to provide low friction oscillation of the mass in the container.

In other circumstances, a rigid volume damper, such as an isolator, is used to minimize performance degradation caused by vibrations. Isolators may include a cylindrical container having a piston slidably mounted therein which divides the container into two sections. A fixed volume of fluid is typically disposed within the container so that when the piston moved through the container, the fluid passes from one section to the other. Balls are disposed between the piston and the inner surface of the container to minimize friction produced by the movement of the piston through the container.

Although the above-described systems operate effectively in most applications, they may not be appropriate to implement in other applications. For example, in circumstances in which the system experiences a disturbance force in the range of micropounds, the systems may not provide appropriate damping. Specifically, in both of the above-mentioned systems, a friction force is generated when the balls bear against the -inner surface of the container, and if the disturbance force is less than the friction force the balls may not rotate and damping may not be provided.

Accordingly, it is desirable to have a system that is operable to damp and/or isolate disturbance forces in the range of micropounds. In addition, it is desirable for the system to be relatively light weight. Moreover, it is desirable for the system to be inexpensive to manufacture. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A system is provided for damping and/or isolating vibration of a mass. The system comprises a housing, a shaft, a housing magnet, and a shaft magnet. The housing has an inner surface defining a passage. The shaft is disposed within said passage of said housing and configured to move axially therein. The shaft has an outer surface. The housing magnet is coupled to the housing inner surface. The shaft magnet is coupled to the shaft outer surface and is in alignment with the housing magnet and configured to repel the housing magnet.

In another embodiment, and by way of example only, an isolator is provided for damping a mass. The isolator includes a housing, a shaft, a seal bellows, a spring, a flexure, a housing magnet, and a shaft magnet. The housing has an inner surface defining a passage. The shaft is disposed within the passage and configured to move axially therein. The shaft has an end and an outer surface. The seal bellows is disposed within the passage and coupled to the shaft end. The spring is disposed within the passage and has a first end and a second end, the first end coupled to the seal bellows and a second end. The flexure is coupled to the second end of the spring and configured to couple to the mass. The housing magnet is coupled to the housing inner surface. The shaft magnet is coupled to the shaft outer surface and is in alignment with the housing magnet and configured to repel the housing magnet.

In still another embodiment, and by way of example only, a tuned mass damper is provided for damping a mass that includes a housing, a shaft, a spring, a housing magnet, and a shaft magnet. The housing has an inner surface defining a passage. The shaft is disposed within the passage and is configured to move axially therein. The shaft has an end and an outer surface. The spring is disposed within the passage and coupled to the shaft end. The housing magnet is coupled to the housing inner surface and the shaft magnet is coupled to the shaft outer surface. The shaft magnet is in alignment with the housing magnet and configured to repel the housing magnet.

### BRIEF DESCRIPTION OF THE DRAWINGS

The present invention will hereinafter be described in conjunction with the following drawing figures, wherein like numerals denote like elements, and

FIG. 1 is a schematic of an exemplary system having vibration isolation;

FIG. 2 is a cross section of an exemplary isolator for use in the system depicted in FIG. 1;

FIG. 3 is a close up view of a portion of the exemplary isolator depicted in FIG. 2;

FIG. 4 is another cross section of the exemplary isolator of FIG. 1 taken along line 3-3;

FIG. 5 is a cross section of another exemplary embodiment of the exemplary isolator of FIG. 1;

FIG. 6 is a schematic of an exemplary system having vibration damping; and

FIG. 7 is a cross section of an exemplary tuned mass damper for use in the system depicted in FIG. 6.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

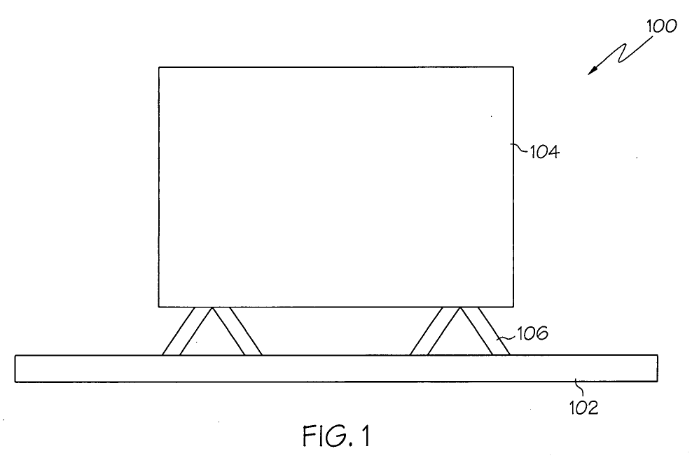

FIG. 1 illustrates an exemplary system having vibration isolation capabilities. System 100 includes a base 102, a payload 104, and at least one isolator 106. System 100 may be implemented in any one of numerous environments, such as in space, terrestrially, or under water. Base 102 is configured to provide a platform to which payload 104 and isolator 106 are coupled and may be any one of numerous application-appropriate devices. For example, in a space application, base 102 can be a satellite, an arm of a satellite, a space station, or any one of numerous other conventionally-used space apparatus. Payload 104 is a device that preferably needs vibration isolation to operate effectively and may be any one of numerous devices, such as, for example, a telescope or a camera. Isolator 106 dampens and isolates vibration that may be experienced by payload 104 and thus, is coupled between payload 104 and base 102. Although FIG. 1 depicts the use of a four isolators, it will be appreciated that fewer or more isolators may be implemented as well.

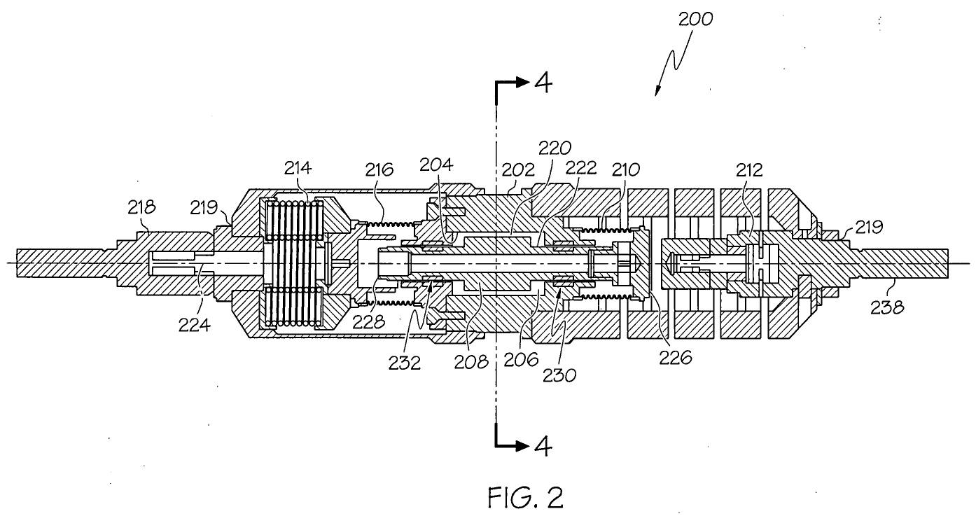

FIG. 2 shows a cross section of an exemplary isolator 200. Isolator 200 includes a housing 202 having an inner surface 204 that defines a passage 206, and a shaft 208, a seal bellows 210, a damper spring 212, a preload spring 214, and compensator bellows 216, each of which is disposed within passage 206. Isolator 200 also includes a flexure 218 coupled to housing 202.

Housing 202 may be constructed from multiple pieces, such as shown in FIG. 2, or alternatively, formed from a single component. Additionally, housing 202 may have openings 219 formed on one or both ends that are configured to couple shaft 208 and other internal components of isolator 200 to base 102 or payload 104.

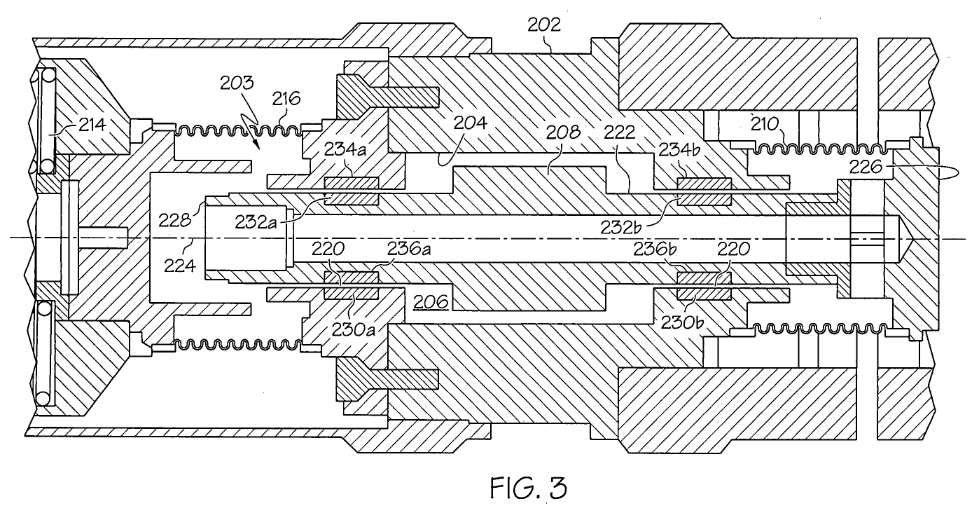

Turning now to FIG. 3, a close up view of a portion of isolator 200 is provided. As shown in FIG. 3, fluid 203 is disposed within housing 202 and moves through sections thereof. Shaft 208 is slidable within housing 202 and moves through passage 206 in an axial direction. Preferably, rotational motion of shaft 208 about a longitudinal axis 224 is not permitted. In this regard, a first end 226 of shaft 208 is fixedly attached to seal bellows 210. In an alternative embodiment, a second end 228 of shaft 108 is fixedly attached to compensator bellows 216. Gaps 220 are included between an outer surface 222 of shaft 208 and inner surface 204 of housing 202. Gaps 220 prevent contact and reduce friction between shaft 208 and housing 202.

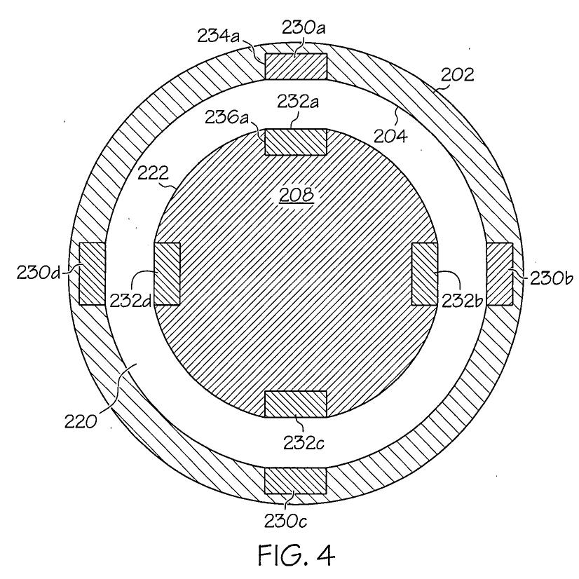

To ensure that gaps 220 are maintained and to further reduce friction between shaft 208 and housing 202, repelling magnets 230a, 230b, 232a, and 232b are included in isolator 200. Magnets 230a, 230b, 232a, and 232b may comprise any conventional, lightweight device used to generate magnetic fields, such as, for example, permanent magnets and electromagnets. Magnets 230a and 230b are coupled to inner surface 204 of housing 202 and may be coupled thereto in any one of a number of manners. For example, inner surface 204 of housing 202 may include grooves 234a and 234b within which magnets 230 may be disposed. Preferably, magnets 230 are spaced substantially equally apart from one another. Magnets 232a and 232b are coupled to outer surface 222 of shaft 208, and similar to magnets 230a and 230b, are coupled in any conventional manner. As shown in FIG. 4, magnets 232a, 232b, 232c, and 232d may be disposed in grooves 236a, 236b, 236c, and 236d that are formed in shaft 208. Additionally, magnets 232a, 232b, 232c and 232d may also be spaced substantially equally apart from each other.

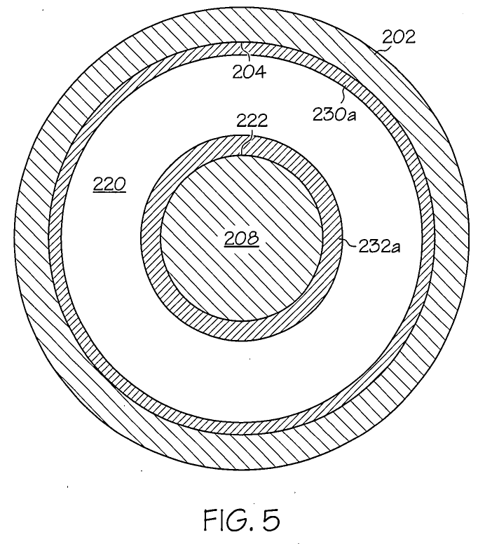

As shown in FIG. 3, each of magnets 230a and 230b is preferably aligned with a corresponding magnet of magnets 232a and 232b. Although four sets of magnets 230a, 230b, 232a, and 232b are shown, more or fewer sets may be incorporated. Moreover, although magnets 230a-230d and 232a-232d are depicted in FIG. 4 as each being a separate piece, they may have any other shape, such as ring-shaped, as shown in FIG. 5.

Returning to FIG. 2, damper spring 212 and preload spring 214 are coupled to seal bellows 210 and compensator bellows 216, respectively. Damper spring 212 and preload spring 214 each has a predetermined stiffness. In one exemplary embodiment, damper spring 212 and preload spring 214 are each removable from housing 102, for example, via openings 219. In such an embodiment, damper spring 212 and preload spring 214 may be replaced with springs having a stiffness that is different than the predetermined stiffness to thereby allow isolator 200 to be tunable.

Flexure 218 is coupled to one end of housing 202 and to preload spring 214 via opening 219. Flexure 218 is further configured to couple to base 102 or payload 104, both shown in FIG. 1. Thus, when base 102 or payload 104 vibrates, the vibration is transferred through flexure 218 to preload spring 214, and finally to shaft 208. It will be appreciated that a second flexure 238 may be coupled to another end of housing 202 and may communicate with damper spring 212.

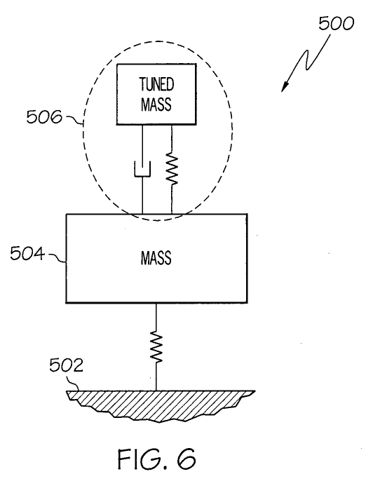

FIG. 6 illustrates another exemplary system 500 having vibration damping capabilities. System 500 includes a base 502, a payload 504, and at least one tuned mass damper 506. System 500 may be implemented in any one of numerous environments, such as in space, terrestrially, or under water. Base 502 is configured to provide a platform to which the payload 504 is coupled and may be any one of numerous application-appropriate devices. For example, in a space application, base 502 can be a satellite, an arm of a satellite, a space station, or any one of numerous other conventionally-used space apparatus. Payload 504 is a device that preferably needs vibration damping to operate effectively and may be any one of numerous devices, such as, for example, a telescope or a camera. Tuned mass damper 506 dampens vibration that may be experienced by payload 504 and may be coupled thereto via various means such as bolts, epoxy, tape, etc.

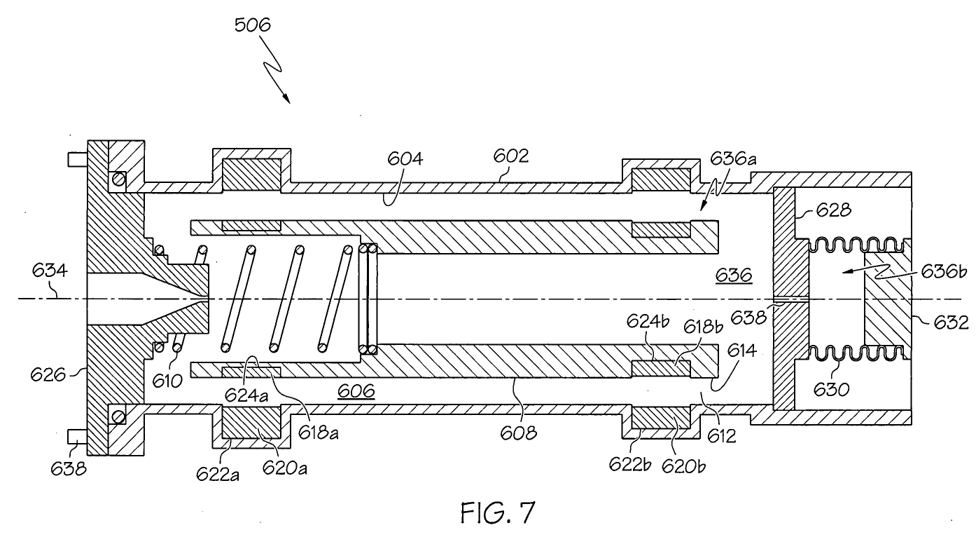

FIG. 7 shows a cross section of an exemplary tuned mass damper 506. Tuned mass damper 506 includes a housing 602 having an inner surface 604 that defines a passage 606, and a shaft 608, a spring 610, a fill cap 626, and a cover 628. Housing 602 defines a volume 636 therein and may be constructed from multiple pieces or alternatively, formed from a single component. Shaft 608 is slidable within housing 602 and moves through passage 606 in an axial direction. Preferably, rotational motion of shaft 608 about a longitudinal axis 634 is not permitted. In this regard, the shaft 608 is fixedly attached to spring 610. A gap 612 is included between an outer surface 614 of shaft 608 and inner surface 604 of housing 602. Gap 612 prevents contact and reduces friction between shaft 608 and housing 602.

To ensure that gap 612 is maintained and to further reduce friction between shaft 608 and housing 602, repelling magnets 618a, 618b, 620a, and 620b are included in tuned mass damper 506, as shown in FIG. 7. Magnets 618a, 618b, 620a, and 620b may comprise any conventional, lightweight device used to generate magnetic fields, such as, for example, permanent magnets and electromagnets. Magnets 618a and 618b are coupled to inner surface 604 of housing 602 and may be coupled thereto in any one of a number of manners. For example, inner surface 604 of housing 602 may include grooves 622a and 622b within which magnets 620a and 620b may be disposed. Preferably, magnets 620a and 620b are spaced substantially equally apart from one another. Magnets 618a and 618b are coupled to outer surface 614 of shaft 604, and similar to magnets 620a and 620b, are coupled in any conventional manner. Magnets 618a and 618b may be disposed in grooves 624a and 624b that are formed in shaft 604. Additionally, magnets 618a and 618b may also be spaced substantially equally apart from each other.

Each of magnets 620a and 620b is preferably aligned with a corresponding magnet of magnets 618a and 618b. Although four sets of magnets 618a, 618b, 620a, and 620b are shown, more or fewer sets may be incorporated. Moreover, although magnets 618a, 618b, 620a, and 620b as each being a separate piece, 618a, 618b, 620a, and 620b may have any other shape.

Spring 610 is coupled between shaft 608 and fill cap 626. Spring 610 has a predetermined stiffness and, in one exemplary embodiment is removable from housing 602, for example, via fill cap 626. In such an embodiment, spring 610 may be replaced with a spring having a stiffness that is different than the predetermined stiffness to thereby allow tuned mass damper 506 to be tunable. The mass of shaft 608 may be increased or decreases also allowing the tuned mass damper 506 to be tunable. In addition to being removable, fill cap 626 restrains shaft 608 from rotating about longitudinal axis 634 and, in this regard, is coupled to housing 602.

Cover 628 divides volume 636 into at least two sections 636a and 636b. Cover 628 has an aperture 638 formed in its center that is provided to allow fluid to be passed between sections 636a and 636b. Cover 628 has an outer peripheral surface that is coupled to housing 602 and is also coupled to bellows 630. Bellows 630 is also coupled to a bellows cap 632. When the temperature of the fluid inside housing 602 increases, fluid is passed through aperture 638 from section 636a into section 636b and bellows 630 is stretched. Consequently, the pressure in housing 602 remains relatively low when temperatures increase, and does not drop significantly when the temperatures decrease.

There has now been provided a system that is operable to damp and/or isolate disturbance forces in the range of micropounds. In addition, the system is relatively light weight. Moreover, the system to inexpensive to manufacture.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A system for damping and/or isolating vibration of a mass, the system comprising:
a housing having an inner surface defining a passage;
a shaft disposed within said passage of said housing and configured to move axially therein, said shaft having an outer surface;
a housing magnet coupled to said inner surface of said housing; and
a shaft magnet coupled to said outer surface of said shaft, said shaft magnet in alignment with said housing magnet and configured to repel said housing magnet.

2. The system of claim 1, wherein said shaft has an end and the system further comprises:
a seal bellows disposed within said passage of said housing and coupled to said end of said shaft.

3. The system of claim 2, further comprising:
a spring disposed within said passage of said housing and coupled to said seal bellows.

4. The system of claim 2, wherein said shaft includes a second end and the isolator further comprises:
a spring disposed within said passage of said housing proximate said second end of said shaft.

5. The system of claim 4, further comprising:
a flexure coupled to said spring, said flexure configured to couple to the mass.

6. The system of claim 1, wherein said shaft includes a second end and the isolator further comprises:
a compensator bellows disposed within said passage of said housing proximate said second end of said shaft.

7. The system of claim 1, further comprising:
a groove formed in said inner surface of said housing, wherein said housing magnet is disposed in said groove.

8. The system of claim 1, further comprising:
a groove formed in said outer surface of said shaft, wherein said shaft magnet is disposed in said groove.

9. The system of claim 1, further comprising:
a second housing magnet coupled to said inner surface of said housing; and
a second shaft magnet coupled to said outer surface of said shaft in alignment with said second housing magnet, said second shaft magnet configured to repel said second housing magnet.

10. The system of claim 9, wherein said housing is cylindrical and said first and second housing magnets are disposed on said inner surface of said housing such that each is equidistant from one another.

11. The isolator of claim 1, wherein said housing magnet is ring-shaped.

12. The isolator of claim 11, wherein said shaft magnet is ring-shaped.

13. The isolator of claim 1, wherein at least one of said housing magnet and said shaft magnet is a permanent magnet.

14. The isolator of claim 1, wherein at least one of said housing magnet and said shaft magnet is an electromagnet.

15. An isolator for damping a mass, the isolator comprising:
a housing having an inner surface defining a passage;
a shaft disposed within said passage of said housing and configured to move axially therein, said shaft having an end and an outer surface;
a seal bellows disposed within said passage of said housing and coupled to said end of said shaft;
a spring disposed within said passage of said housing, said spring having a first end and a second end, said first end coupled to said seal bellows;
a flexure coupled to said second end of said spring, said flexure configured to couple to the mass;
a housing magnet coupled to said inner surface of said housing; and
a shaft magnet coupled to said outer surface of said shaft, said shaft magnet in alignment with said housing magnet and configured to repel said housing magnet.

16. The isolator of claim 15, further comprising:
a groove formed in said inner surface of said housing, wherein said housing magnet is disposed in said groove.

17. The isolator of claim 15, further comprising:
a groove formed in said outer surface of said shaft, wherein said shaft magnet is disposed in said groove.

18. The isolator of claim 15, further comprising:
a second housing magnet coupled to said inner surface of said housing; and
a second shaft magnet coupled to said outer surface of said shaft in alignment with said second housing magnet, said second shaft magnet configured to repel said second housing magnet.

19. A tuned mass damper for damping a mass, the tuned mass damper comprising:
a housing having an inner surface defining a passage;
a shaft disposed within said passage of said housing and configured to move axially therein, said shaft having an end and an outer surface;
a spring disposed within said passage of said housing and coupled to said end of said shaft;
a housing magnet coupled to said inner surface of said housing; and
a shaft magnet coupled to said outer surface of said shaft, said shaft magnet in alignment with said housing magnet and configured to repel said housing magnet.

20. The isolator of claim 19, further comprising:
a second housing magnet coupled to said inner surface of said housing; and
a second shaft magnet coupled to said outer surface of said shaft in alignment with said second housing magnet, said second shaft magnet configured to repel said second housing magnet.
